(19) United States
(12) Patent Application Publication
(10) Pub. No.: US 2026/0036447 A1
(43) Pub. Date: Feb. 5, 2026

(54) Fibre Optic Sensing

(71) Applicant: OptaSense Holdings Limited, Camberley, Surrey (GB)

(72) Inventors: Roger Crickmore, Camberley, Surrey (GB); Alastair Godfrey, Camberley, Surrey (GB)

(21) Appl. No.: 18/995,811

(22) PCT Filed: Jun. 26, 2023
(86) PCT No.: PCT/GB2023/051667

§ 371 Date: Jan. 16, 2025

(30) Foreign Application Priority Data
Jul. 29, 2022 (GB) 2211111.6

(51) Int. Cl. G01D 5/353; G01K 11/32; G01L 1/24

(52) U.S. Cl. CPC G01D 5/35361; G01K 11/32; G01L 1/242

(57) ABSTRACT

A fibre optic sensing apparatus (400) is described which has an optical output path (403, 405, 404) configured to repeatedly interrogate a sensing optical fibre (402) by launching coherent optical radiation into the sensing optical fibre. A detector (407) is configured to receive optical radiation that is Rayleigh backscattered from the sensing optical fibre and output a detected backscatter signal in response to each interrogation and a processor (408) processes the detected backscatter signal. The apparatus is operable in a frequency swept mode, in which the sensing optical fibre is interrogated with a first set of interrogations of coherent optical radiation having different optical frequencies from one another to acquire, for at least one sensing portion of the sensing optical fibre, a backscatter spectral profile (201) of a measurement value of the detected backscatter signal with frequency across a first frequency range. The processor is configured to combine a plurality of said backscatter spectral profiles (201, 202) to form a reference profile (203) with an effective frequency range greater than the first frequency range

This application relates to methods and apparatus for fibre optic sensing.

Various types of fibre optic sensing are known, where an optical fibre is deployed in an area of interest as a sensing fibre and interrogated using optical radiation to determine information about the environment around the sensing fibre and/or stimuli acting on the sensing fibre.

One type of fibre optic sensing involves repeatedly interrogating the sensing optical fibre with coherent optical radiation, where each interrogation comprises optical radiation with the same frequency characteristics, and detecting and analysing optical radiation which is Rayleigh backscattered from within the sensing fibre. The interrogating radiation may be Rayleigh backscattered from intrinsic scattering sites within the optical fibre that are inherently present in an optical fibre. A disturbance acting on the sensing fibre can result in a change in optical path length for the sensing portion, e.g. a physical change in length of that part of the sensing fibre and/or a modulation of the refractive index, which can alter the distribution of the scattering sites and lead to variation in the properties of the backscatter, which can be detected. The backscatter may be processed in time bins corresponding to the return trip time to different sections or sensing portions of the sensing optical fibre according to the principles of optical time domain reflectometry (OTDR), so as to provide independent sensing of a plurality of sensing portions. Such distributed fibre optic sensing may thus be termed COTDR sensing (coherent OTDR).

Another type of fibre optic sensing has been proposed where the sensing optical fibre is repeatedly interrogated with coherent optical radiation, but where the optical frequency of the interrogating radiation is varied over the course of a number of interrogations, e.g. the optical frequency is swept across a defined frequency range. For each sensing portion, a measurement value is determined from the Rayleigh backscatter, which could be a measure of the signal level or intensity of the Rayleigh backscatter or the level of a carrier signal, at each optical frequency to effectively provide a backscatter spectral profile of how the measurement value varies with frequency. The backscatter spectral profile can be used to detect changes in state of the sensing portion, i.e. changes in optical path length affecting the sensing portion such as due to strain and/or temperature, to be determined. Changes in optical path length of a given sensing portion can result in a change in backscatter at a given frequency that is similar to the variation that would result from a variation in optical frequency (with no change in optical path length). Thus, if a new backscatter spectral profile were obtained and compared to a previously acquired profile, then, for a sensing portion where there had been no change in state, the two backscatter spectral profiles would be expected to be substantially the same. However, for a sensing portion where there had been a change in optical path length, the newly acquired backscatter spectral profile would be expected to show an apparent frequency shift compared to the previously acquired profile, with the extent of the frequency shift indicating the amount of change in optical path length. By periodically acquiring backscatter spectral profiles and comparing the newly acquired profiles to a previously acquired profile, strain and/or temperature changes affecting the sensing fibre can be detected.

Such frequency swept coherent Rayleigh sensing can be advantageous in that the sensing need not be performed continually. A backscatter spectral profile can be determined at any time and compared to a previously acquired reference profile. However, the extent of the maximum change in optical path length (and hence strain or temperature) that can be measured is limited to the frequency range over which the source of the coherent radiation can be scanned. Optical systems which may be used conventionally for COTDR sensing must be low noise and generally may have only a limited range over which they could be frequency swept, so implementing a frequency swept coherent Rayleigh sensor may require a dedicated optical source arrangement. In addition, as the frequency is varied between interrogations, implementing a relatively wide frequency range with sufficient frequency resolution can require a relatively large number of interrogations, which means that it can take a relatively long time to acquire a backscatter spectral profile.

Embodiments of the present disclosure relate to improved methods and apparatus for fibre optic sensing.

Thus, according to an aspect of the disclosure, there is provided a fibre optic sensing apparatus, comprising: an optical output path configured to repeatedly interrogate a sensing optical fibre by launching coherent optical radiation into the sensing optical fibre; a detector configured to receive optical radiation that is Rayleigh backscattered from the sensing optical fibre and output a detected backscatter signal in response to each interrogation; and a processor for processing the detected backscatter signal. The fibre optic sensing apparatus is operable in a frequency swept mode, in which the sensing optical fibre is interrogated with a first set of interrogations of coherent optical radiation having different optical frequencies from one another to acquire, for at least one sensing portion of the sensing optical fibre, a backscatter spectral profile of a measurement value of the detected backscatter signal with frequency across a first frequency range. The processor is configured to combine a plurality of said backscatter spectral profiles to form a reference profile with an effective frequency range greater than the first frequency range.

In some examples, the processor may be configured to: identify at least first and second backscatter spectral profiles acquired across the first frequency range, in which there is a common part of the first spectral backscatter spectral profile that, with an apparent frequency shift, is the same as a common part of the second backscatter spectral profile and in which parts of each of the first and second backscatter spectral profiles are different from one another; and combine the first and second backscatter profiles to form the reference profile to include the part of the first profile backscatter spectral profile which is different to the second backscatter spectral profile, the common part of the first and second backscatter spectral profiles and the part of the second profile backscatter spectral profile which is different to the first backscatter spectral profile. In some example, the part of the reference profile that corresponds to the common part of the first and second backscatter spectral profiles may be formed by averaging the common parts of the first and second backscatter spectral profiles.

In some cases, the processor may be configured to compare an existing reference profile with an acquired backscatter spectral profile over the first frequency range to determine the extent of any apparent frequency shift. The processor may be configured to determine the apparent frequency shift by cross-correlating the acquired backscatter spectral profile with the reference profile. The processor may be configured to determine whether, with the determined apparent frequency shift applied to the existing reference profile, part of the acquired backscatter spectral profile extends beyond the existing reference profile and, if so, to combine acquired backscatter spectral profile with the existing reference profile to create a new reference profile that includes the part of the acquired backscatter spectral profile extends beyond the existing reference profile. The processor may be configured to output an output signal indicative of the determined apparent frequency shift.

In some examples, the processor may be configured to combine a plurality of acquired backscatter spectral profiles to generate a measurement profile and to compare the measurement profile to the reference profile to determine the extent of any apparent frequency shift and to output an output signal indicative of the determined apparent frequency shift.

The processor may be configured to determine a magnitude of change in strain and/or temperature based on the determined apparent frequency shift.

In some examples the processor may be configured to determine the measurement value as the signal level of the detected backscatter signal.

In some examples, the apparatus may further comprise a mixer for mixing the optical radiation that is Rayleigh backscattered from the sensing fibre with a local oscillator derived from the optical output path prior to detection by the detector, wherein the optical output path is configured such that there is an optical frequency difference between the local oscillator and the optical radiation that is Rayleigh backscattered from the sensing fibre. The processor may be configured to determine the measurement value as a carrier level of a carrier component in the detected backscatter signal at a carrier frequency equal to said optical frequency difference.

The fibre optic sensing apparatus may further be operable in a COTDR mode, in which the sensing optical fibre is repeatedly interrogated coherent optical radiation, wherein the interrogations in the COTDR mode have the same frequency characteristics as one another and the detected backscatter signal is processed to determine, for at least one sensing portion of the sensing optical fibre, a phase value indicative of any changes in optical path length and to output a COTDR output signal based on said determined phase value. The optical output path may comprise a first laser and the apparatus may be configured to use the first laser in each of the frequency swept mode and the COTDR mode. In some examples, the apparatus may be configured to operate in the COTDR mode in intervals between periods of operation in the frequency swept mode and the processor may be configured to use an indication of any change in optical path length determined from periods of operation in the frequency swept mode of operation to identify and/or correct any demodulation errors in the COTDR output signal. In some examples, the apparatus may be configured to operate in the COTDR mode both during the periods of operation in the frequency swept mode and during the periods between them, and the processor may be configured remove a signal component induced by the frequency sweep from a COTDR output signal generated in the COTDR mode. The apparatus may be configured to use an indication of any change in optical path length determined from periods of operation in the frequency swept mode of operation to identify and/or correct any demodulation errors in the COTDR output signal.

In another aspect there is provided a method of fibre optic sensing comprising: repeatedly interrogating a sensing optical fibre by launching coherent optical radiation into the sensing optical fibre; a detecting optical radiation that is backscattered from the sensing optical fibre and output a detected backscatter signal in response to each interrogation; and processing the detected backscatter signal. The method comprises operating in a frequency swept mode in which the sensing optical fibre is interrogated with a first set of interrogations of coherent optical radiation having different optical frequencies from one another to acquire, for at least one sensing portion of the sensing optical fibre, a backscatter spectral profile of a measurement value of the detected backscatter signal with frequency across a first frequency range; and combining a plurality of said backscatter spectral profiles to form a reference profile with an effective frequency range greater than the first frequency range.

The method may be operated with any of the variants as described with reference to the first aspect.

Note that unless expressly indicated to the contrary or clearly incompatible, any feature of any of the embodiments described herein may be used in combination with any one or more features of any of the other described embodiments.

Embodiments, and feature of embodiments of the present disclosure, will now be described by way of example only with respect to the accompanying drawings, of which:

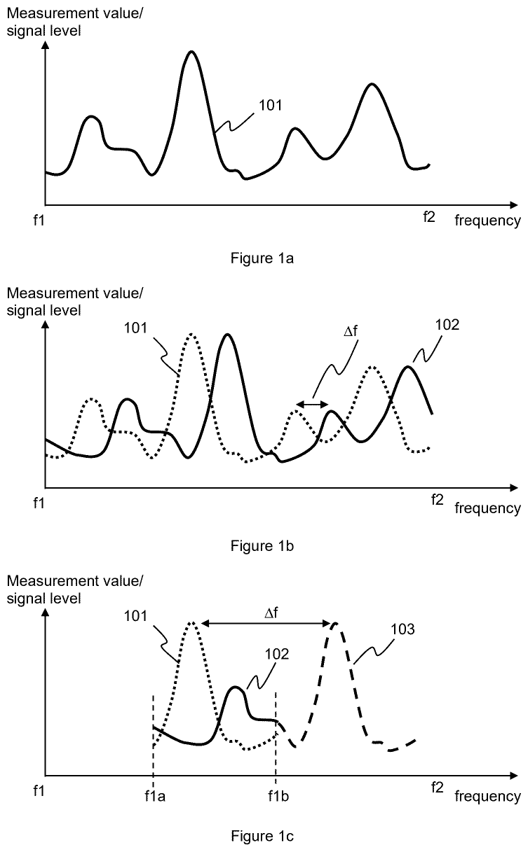

FIGS. 1a, 1b and 1c illustrate backscatter spectral profiles;

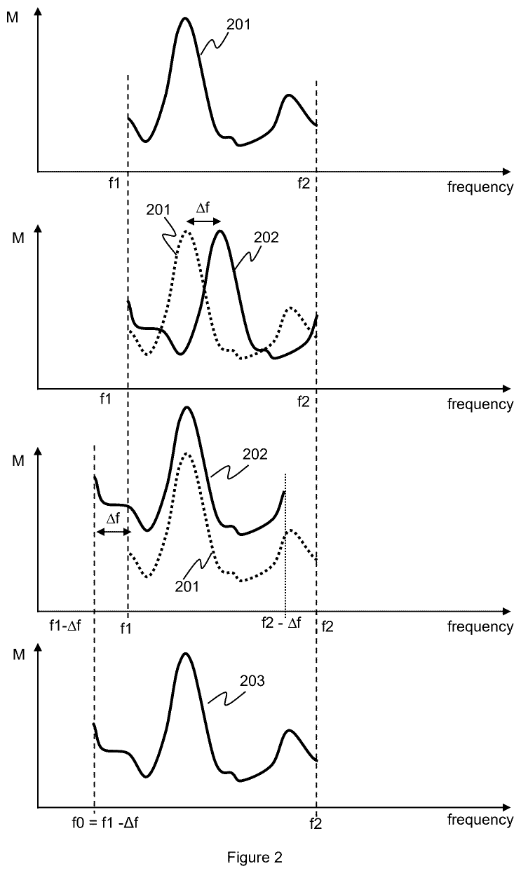

FIG. 2 illustrates combination of backscatter spectral profiles to form a reference profile;

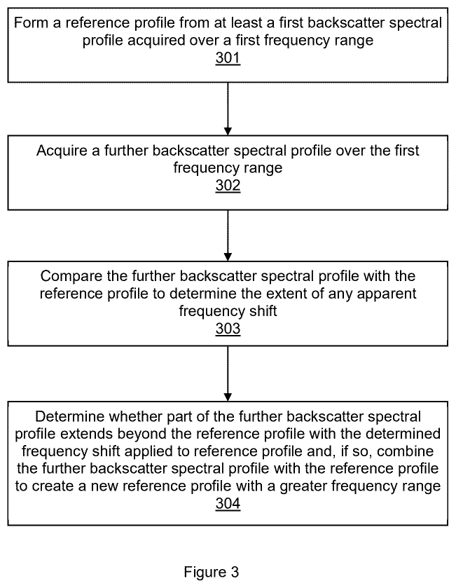

FIG. 3 illustrates a flow chart of a method of an embodiment; and

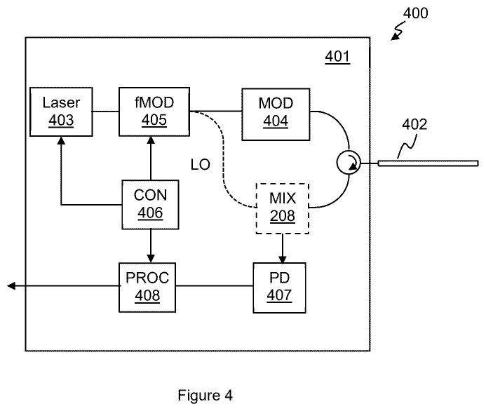

FIG. 4 illustrates a coherent Rayleigh backscatter distributed fibre optic sensor according to an embodiment.

Embodiments of the present disclosure relate to methods and apparatus for fibre optic sensing, and in particular to frequency swept coherent Rayleigh backscatter sensing.

As noted above, frequency swept coherent Rayleigh backscatter sensing has been proposed to allow monitoring of stimuli acting on a sensing fibre that impart a change in optical path length, such as temperature and/or strain.

A profile of how Rayleigh backscatter from a given sensing portion varies with optical frequency of interrogating radiation, i.e. a backscatter spectral profile, is obtained. Such a profile has a dependence on optical path length of the sensing portion, and a variation in optical path length of a sensing portion can lead to a detectable change in the backscatter spectral profile that can be used to quantify the change in optical path length. Thus, backscatter spectral profiles for a given sensing portion can be determined at first and second different times, which could be separated by any desired interval, and by comparing the backscatter spectral profiles acquired at the different times, changes in optical path length of the relevant sensing portion between the first and second times may be determined from the amount of apparent frequency shift between the different profiles.

To generate the backscatter spectral profile, the sensing optical fibre is interrogated with a first set of interrogations, where each interrogation involves launching coherent optical radiation into the sensing fibre and detecting Rayleigh backscatter. The optical frequency of the interrogating optical radiation is controllably varied between different interrogations of the first set. The Rayleigh backscatter from the first set of different interrogations at different frequencies is used to form the backscatter spectral profile, which is a profile of how a measurement value derived from the Rayleigh backscatter for the sensing portion varies with frequency. In some implementations the measurement value may be the signal level, i.e. backscatter intensity, of the backscatter for that sensing portion at each frequency, although in some embodiments a carrier signal could be generated, as will be discussed in more detail below, and the measurement value may be determined as a signal level of the carrier signal.

Each interrogation thus involves launching coherent optical radiation into the sensing fibre. The phenomenon of Rayleigh backscattering results in some fraction of the interrogating radiation input into the sensing fibre being reflected back to the interrogator, where it is detected. As the interrogating radiation is coherent, any backscatter arriving at the detector at the same time will interfere and thus the backscatter from the sensing optical fibre will depend, at least partly, on the distribution of inherent scattering sites within the optical fibre, which will vary effectively randomly along the length of the fibre. Thus the backscatter characteristics, e.g. intensity, from any given interrogation will exhibit a random variation from one sensing portion to the next. In the absence of any environmental stimulus, the backscatter characteristics from any given sensing portion should remain the same, and thus if the sensing portion were repeatedly interrogated with optical radiation having the same optical frequency (and same pulse duration, amplitude etc.) it would be expected that the backscatter characteristics would be the same for each such interrogation. However, an environmental stimulus acting on the relevant sensing portion of the fibre can result in a change of optical path length for that section of fibre, e.g. through stretching/compression of the relevant section of fibre and/or a refractive index modulation. This can vary the distribution of the scattering sites within the relevant sensing portion, which can vary the degree of interference and hence the detected backscatter. This is the principle of known COTDR, which repeatedly interrogates the sensing fibre with interrogating radiation having the same frequency (and other) characteristics.

For frequency swept operation, the frequency of the interrogating radiation is varied between interrogations. The change in optical frequency between interrogations changes the phase of the radiation backscattered from each of the scattering sites, with a resultant change in interference of the backscatter and hence the measurement value.

FIG. 1a illustrates a hypothetical example of how the measurement value may vary with frequency of the interrogating radiation for a sensing portion, in this case in a frequency range from f1 to f2. This variation in measurement value with frequency provides a backscatter spectral profile 101 which can be used as a characteristic for the relevant sensing portion to subsequently determine changes in state of the sensing portion, i.e. changes in optical path length affecting the sensing portion such as due to strain and/or temperature. This acquired backscatter spectral profile 101 may thus be used as a reference profile. Note that FIG. 1a illustrates the profile of variation in measurement value against frequency, but it will be understood that the profile could instead be represented as a profile of variation of measurement signal with wavelength.

Changes in optical path length of a given sensing portion, that affect substantially the whole of that sensing portion equally, can result in a change in backscatter at a given frequency that is similar to the variation that would result from a variation in frequency (with no change in optical path length). Consider just two reflectors within a sensing portion that are separated by an optical path length L. The phase difference between radiation backscattered from the two reflectors is given by θ=4πLf/c, where f is the frequency of the radiation and c is the speed of light. Therefore, changing the frequency, of the interrogating radiation, with no change in optical path length, will vary the phase in a similar way to changing the optical path length L whilst maintaining the frequency.

Thus, the backscatter spectral profile of how measurement value varies with frequency of interrogating radiation would be expected to be substantially the same as a profile of how the measurement value (at a fixed frequency of interrogating radiation) would vary with changes in optical path length.

Thus, by interrogating the sensing optical fibre with interrogating radiation at different frequencies and generating a measurement value for each of the different frequencies, a backscatter spectral profile can be generated which provides an indication of how the measurement signal value, at any frequency, may be expected to change with changes in optical path length.

Subsequently, at some later time, the sensing fibre may again be interrogated with coherent optical radiation, where the frequency of the interrogating optical radiation varies, over different interrogations, over at least part of the same frequency range, to determine a new backscatter spectral profile.

If there had been no change to the state of the relevant sensing portion, i.e. no change to the optical path length of that portion, the relevant backscatter spectral profile of measurement value with frequency would be expected to be substantially the same as the reference profile recorded previously. If, however, there has been a change in optical path for the relevant sensing portion, the operating point for the sensing portion will have changed and thus the measurement value for a given frequency of interrogating radiation would be expected to be different to that measured previously. As discussed above, the change in optical path length will provide a similar effect to a change in frequency (and hence wavelength) and thus the effect of the change in optical path length can be seen as having a similar effect as a shift in frequency of the interrogating radiation. However, taking such an effective shift in frequency into account, the variation of measurement value with frequency of interrogating radiation would be expected to exhibit the same general pattern as the previously determined profile.

FIG. 1b illustrates this principle. FIG. 1b illustrates an example of a backscatter spectral profile 102 of measurement value with frequency of interrogating radiation for the same sensing portion as that illustrated in FIG. 1a, but where there has been a change in optical path length. The profile 102 has the same general pattern of variation as the previously acquired reference profile 101, but the change in optical path length results in an apparent shift in frequency Δf of the newly acquired profile 102 compared to the reference profile 101. The apparent shift in frequency Δf is related to the change in optical path length.

Detecting any frequency shift in the backscatter spectral profile for a sensing portion can thus be used as an indication of a change in optical path length and determining the amount of the frequency shift can quantify the amount of change. The amount of any frequency shift may be determined in various different ways, but in general a newly acquired backscatter spectral profile may be compared with a previously acquired backscatter spectral profile to determine the amount of any frequency shift. Conveniently the newly acquired backscatter spectral profile may be cross-correlated with the previous backscatter spectral profile to determine the amount of any frequency shift, but it will be understood that other techniques may be used, for instance feature analysis may identify one or more features which correspond between the relevant profiles, e.g. one or more peaks.

Note that the discussion above has focused on determining an amount of frequency shift. This could be determined by comparison of profiles of measurement value with frequency, as discussed with reference to FIGS. 1a and 1b. It will be understood, however, that the amount of any frequency shift is related to a corresponding wavelength shift, and it would be possible to generate a profile of measurement value with wavelength of interrogating radiation and determine the amount of any wavelength shift to determine the extent of any change in optical path length. It will be understood that a profile of measurement value with wavelength is related to a profile of measurement value with frequency and thus either can be seen as a backscatter spectral profile and, as used herein, a determination of a frequency shift shall be taken as including a determination of a wavelength shift.

As noted above, however, the maximum of amount of change in optical path length, and hence, the maximum change in strain or temperature that can be detected, is related to frequency range over which the backscatter spectral profile is obtained. If the change in optical path length leads to an apparent shift in frequency of the backscatter spectral profile which is of the order of the frequency range over which the profile is acquired, or greater, there may be no correlation between the newly acquired backscatter spectral profile and the previously acquired backscatter spectral profile.

FIG. 1c illustrates this principle. FIG. 1c illustrates that the reference profile 101 for a sensing portion is only obtained over a more limited frequency range, in this example between frequencies f1a and f1b. The newly acquired backscatter spectral profile 102 may also be acquired over the same frequency range, i.e. between f1a and f1b. In this example, however, there is no correlation between the newly acquired backscatter spectral profile 102 and the reference profile 101. Thus it would not be possible to determine the extent of any apparent frequency shift and it would not be possible to quantify the amount of change in optical path length. In effect, the amount of frequency shift Δf is large enough so that, for the newly acquired profile, the part 103 of the profile that would correspond to the reference profile 101 has been shifted mostly or wholly outside of the frequency window over which the new backscatter spectral profile is acquired.

Thus, generally, the frequency range over which the optical frequency is varied is set with respect to the maximum change in optical path length it is wished to measure. However, this can require the optical frequency to be scanned over a relatively large frequency range, which can be disadvantageous for various reasons.

In some cases it may be desirable for the same apparatus, e.g. interrogator unit, to be operable to selectively perform frequency swept Rayleigh backscatter sensing as discussed above or COTDR Rayleigh sensing, where the fibre is repeatedly interrogated with interrogating radiation having the same frequency characteristics for each interrogation. In other words, it may be desirable for the same apparatus to be operable in a frequency swept mode or in a COTDR mode. COTDR sensing is generally more sensitive than frequency swept Rayleigh sensing and provides an updated measurement value from each interrogation. However, COTDR sensing relies on continuous monitoring and phase-based COTDR sensing, which provides a quantitative value of strain/temperature changes, may be subject to demodulation errors if the monitored phase changes by more than IT radians between each interrogation, as may happen with short impulsive disturbances on the sensing fibre. Providing an apparatus that can selectively operate in a frequency swept mode or a COTDR mode may advantageously allow an appropriate sensing mode to be selected for a particular application and/or allow operation mainly in the COTDR mode, but with periodic operation in the frequency swept mode, for calibration or correction of any demodulation errors in operation in the COTDR mode.

For COTDR Rayleigh sensing, the optical source arrangement should be low noise, and generally an optical source suitable for COTDR sensing may only be capable of being swept over a relatively limited frequency range, which may be less than the frequency range desired for operation in the frequency swept mode. Thus a separate dedicated optical arrangement may be required to provide frequency sweeping over the full frequency range desired, which adds to the cost and complexity of the system.

Also, the extent of the frequency range (together with the frequency separation between the different frequencies of the different interrogations) determine how many interrogations are needed to generate the profile, and thus the time required to acquire the profile. In general the frequency separation may be fixed and set so as to provide sufficient detail in the resulting backscatter spectral profile to allow correlation between profiles acquired at different times. Therefore, the greater the frequency range for the profile, the more interrogations will be required to generate the profile, which can in some cases mean that acquiring a backscatter spectral profile may take a relatively significant amount of time.

Embodiments of the present disclosure relate to methods and apparatus for frequency swept Rayleigh backscatter sensing in which backscatter spectral profiles are periodically acquired with the optical frequency swept over a first frequency range and in which a plurality of backscatter spectral profiles are combined to form a reference profile which has an effective frequency range greater than the first frequency range.

Thus, for example, a first backscatter spectral profile over the first frequency range can be obtained at a first time. A second backscatter spectral profile over substantially the same first frequency range can be obtained at a second different time. If the second backscatter spectral profile correlates to the first backscatter spectral profile, but with an apparent frequency shift, then part of the second backscatter spectral profile will correspond to, i.e. match or be the same as, part of the first backscatter spectral profile, but part of the first backscatter spectral profile will be different to the second profile and part of the second backscatter spectral profile will be different to the first profile. This different part of the second backscatter spectral profile can be seen as a new part of an inherent characteristic pattern and the first and second backscatter spectral profiles can be combined to form a new reference profile that includes all the first backscatter spectral profile together with the new part of the second backscatter spectral profile. As such the reference profile will extend over a frequency range greater than the first frequency range.

In effect, it can be considered that, for each sensing portion of the sensing fibre, there is an inherent characteristic pattern associated with each sensing portion of how the measurement value from a sensing portion varies with frequency and optical path length. Interrogating the sensing fibre in a frequency sweep mode to generate a backscatter spectral profile across a first frequency range can be seen as revealing the part of the inherent characteristic pattern that is within (for the given strain/temperature state of the sensing portion) the frequency window defined by the first frequency range. Such a backscatter spectral profile can be used as an initial reference profile. Any change to the strain/temperature state of the sensing portion varies the part of the inherent characteristic pattern that is within the frequency window and thus generating a new backscatter spectral profile across the first frequency range will reveal some new part of the inherent characteristic pattern. By combining the acquired backscatter spectral profiles appropriately, a single reference profile can be generated that includes different parts of the inherent characteristic pattern from the different acquired backscatter spectral profiles to provide a reference profile over a frequency range that is greater than the extent of any single acquired backscatter spectral profile. Thus, any backscatter spectral profiles where at least part of the profiles correspond but part of the profiles are different can thus be combined to provide a reference profile of a larger frequency range.

FIG. 2 illustrates this principle. FIG. 2 illustrates, in the top plot a first backscatter spectral profile 201 of measurement value M, i.e. signal or carrier signal level, against frequency of interrogating radiation for a given sensing portion obtained at a first time. The first backscatter spectral profile is obtained across a frequency range between frequencies f1 and f2. The second plot also shows a second backscatter spectral profile 202 of measurement value M against frequency of interrogating radiation for the same sensing portion obtained at a second, different time. The second backscatter spectral profile is also obtained over the same frequency range f1 to f2.

As discussed above, if the optical path length of the relevant sensing portion is the same at the first time as at the second time, then the second backscatter spectral profile would be expected to be substantially identical to the first backscatter spectral profile.

However, in the case where there has been a change in optical path length, as illustrated in FIG. 2, the second backscatter spectral profile will have an apparent frequency shift compared to the first. If the apparent frequency shift is less than the extent of the frequency range f1 to f2, then part of the second backscatter spectral profile will be the same as part of the first profile. FIG. 2 illustrates the second backscatter spectral profile 202 has been frequency shifted by an amount Δf with respect to the first backscatter spectral profile 201.

The third plot of FIG. 2 illustrates the first backscatter profile 201 and also a frequency shifted version of the second backscatter profile 202, where the second backscatter profile has been shifted by an amount Δf to match the first backscatter profile (note this figure shows the frequency shifted version displaced vertically from the first backscatter profile purely for clarity).

In this example, the part of the first backscatter spectral profile 201 that extends from f1 to f2−Δf is thus substantially the same as part of the frequency shifted second backscatter spectral profile 202, i.e. is a common part. However the part of the first backscatter spectral profile between f2−Δf and f2 is different to any of the second backscatter spectral profile and represents a different part of the underlying characteristic pattern for the sensing portion. In this example, it can be seen, however, that due to the apparent frequency shift applied to the second backscatter spectral profile, it is known how the measurement value M would have been expected to vary in the frequency range f1−Δf to f1, even though the frequency used for acquisition of each backscatter spectral profile does not extend below f1.

The first and second backscatter spectral profiles 201 and 202 may be combined to create a reference profile 203, as illustrated in the bottom plot. In this case the reference profile 203 extends over a frequency range from f0 to f2, where f0=f1−Δf. The part of the reference profile 203 from f1−Δf to f1 is taken from the second backscatter spectral profile 202. The part of the reference profile from f2−Δf to f2 is taken from the first profile 201. The common part of the reference profile from f1 to f2−Δf may be taken from the first backscatter spectral profile or the second backscatter spectral profile or may be a combination from both backscatter spectral profiles. For instance, the measurement value at each of the individual frequencies within this range could be combined, say by averaging, from the two backscatter spectral profiles, which can help to reduce noise for this part of the reference profile.

Note the reference profile 203 illustrated in FIG. 2 is illustrated as extending over the range f0 (=f1−Δf) to f2 and is the same as the first backscatter spectral profile 201 over the scanned frequency range f1 to f2. In this case, the reference profile 203 represents a reference profile for the state of the sensing portion as the first time, when the first backscatter spectral profile is acquired. It will be understood, however, that it would alternatively be possible to form the reference profile to extend over a frequency range of f1 to f3=f2+Δf, and which is the same as the second backscatter spectral profile 202 over the range f1 to f2, and which would represent a reference profile for the state of the sensing portion as the second time, when the second profile is acquired.

The reference profile 203 thus extends over a frequency range which is greater than that of either of the acquired backscatter spectral profiles used to create it. In effect, the variation in optical path length experienced by the sensing portion is used to provide synthetic frequency sweeping of the relevant sensing portion, so as to allow build up of a reference profile.

This principle can be extended to the combination of more than two backscatter spectral profiles. Further backscatter spectral profiles may be obtained and where any newly acquired backscatter spectral profile can be identified as having part in common with the existing reference profile and part which extends beyond the existing reference profile, the new part of the backscatter spectral profile can be added to the existing reference profile to extend the reference profile. As mentioned above, the various parts of the backscatter spectral profiles that are in common may be combined, say by averaging, to improve the quality of the reference profile, e.g. reduce noise.

In use, backscatter spectral profiles can be acquired at any desired intervals, which may be regular or irregular as desired for any particular application, and compared to the existing reference profile to determine the amount of any shift in wavelength between the newly acquired backscatter spectral profile and the reference profile. As the reference profile can be formed to have a frequency extent greater than, and in some cases much greater than, the frequency range over which the new backscatter spectral profile is acquired, the extent of frequency shift, and hence the extent of the change in optical path length, that can determined is greater.

This can allow an optical system which has a relatively limited range of frequency scanning to be used to acquire the individual backscatter spectral profiles which are combined to form the reference profile. In use, a plurality of backscatter spectral profiles may be acquired and used to form a reference profile over a frequency range which is greater than the limited scanning range. Such a sensor may then subsequently be used in the frequency swept mode at desired intervals to allow quantitive determination of the amount of change in optical path length over a greater range.

In particular, some embodiments of the present disclosure may use an optical system suitable for COTDR Rayleigh sensing.

In some implementations, to build the reference profile, a sensing apparatus may initially be operated in a frequency swept mode, with a relatively short interval between acquisition of backscatter spectral profiles. Acquiring multiple profiles with a relatively short duration between acquisition of the profiles may limit the amount of change of strain/temperature expected for the sensing portions and thus increase the chance of at least some overlap of the backscatter spectral profiles, i.e. the backscatter spectral profiles having at least some part in common. The sensor could be operated in this way until the reference profiles for at least some sensing portions extend over a certain desired frequency range. Subsequently the interval between acquisition of successive backscatter spectral profiles may be reduced, as the greater frequency extent of the reference profile can allow for greater changes in optical path length to be determined.

In some implementations, a newly acquired backscatter spectral profile may be compared to the existing reference profile to determine the amount of any apparent frequency shift so as to determine any change in optical path length for the sensing portion, whilst also determining whether any part of the newly acquired backscatter spectral profile could extend the range of the existing reference profile.

In some cases, each acquired backscatter spectral profile could be compared to the reference profile individually. However, in some cases, it may be preferable to combine a plurality of newly acquired backscatter spectral profiles into a combined measurement profile before comparison to the reference profile. The plurality of newly acquired backscatter spectral profiles may be combined into the measurement profile in a similar way as for forming the reference profile. As well as again averaging multiple backscatter spectral profiles to reduce the noise, if the strain/temperature is changing over the period of acquisition, the measurement profile will exist over a wider frequency range than an individual backscatter spectral profile which may enable more accurate cross correlation. By comparing the shifts between the individual backscatter spectral profiles used to make up this measurement profile, the minimum and maximum strains within this period and when they occurred, can be determined.

FIG. 3 illustrates a flow chart of a method according to an embodiment for generating a reference. In block 301 the method involves forming a reference profile from at least a first backscatter spectral profile acquired over a first frequency range. Initially, the reference profile may be formed from just a single backscatter spectral profile, but over time as the method is performed, the reference profile can be formed from a plurality of backscatter spectral profiles acquired over the first frequency range.

In block 302 the method involves acquiring a further backscatter spectral profile over the first frequency range. In some cases, where the processing is performed contemporaneously with the interrogation of the sensing fibre, acquiring the further backscatter spectral profile may involve interrogating the sensing fibre with optical radiation at different frequencies and forming the further backscatter spectral profile. However, the method of the present embodiment may be performed remotely from the actual sensing apparatus and/or using backscatter spectral profiles previously obtained through sensing and thus acquiring the further backscatter spectral profile may involve receiving the relevant backscatter spectral profile over a suitable communication links or from a suitable memory or data store.

In block 303 the method involves comparing the further backscatter spectral profile with the reference profile to determine the extent of any apparent frequency shift. The extent of any determined frequency shift could then be used to provide an indication of the extent of change in optical path length for the relevant sensing portion. In some cases the further backscatter spectral profile may be combined with one or more additional backscatter spectral profiles to form a measurement profile prior to the comparison. The comparison may involve cross-correlation between the further backscatter spectral profile and the reference profile.

In block 304 the method involves determining whether, with the determined frequency shift applied to reference profile, part of the further backscatter spectral profile extends beyond the reference profile. If so, the method involves combines the further backscatter spectral profile with the reference profile to create a new reference profile. The new reference profile will have a greater a frequency range than the previous reference profile. The method may then be repeated using the new reference profile as the reference profile.

FIG. 4 illustrates one example of a distributed fibre optic sensing apparatus 400 which according to an embodiment.

The sensing apparatus 400 comprises an interrogator 201 which, in use, is optically coupled to an optical fibre 402 which is to be used for sensing. The optical fibre 402, may be referred to herein as the sensing optical fibre or just sensing fibre (or sometimes as the fibre under test).

The sensing fibre 402 can be many kilometres in length and can be tens of kilometres in length, say up to 40 km or more or up to 100 km or more in some implementations. For coherent Rayleigh distributed fibre optic sensing, the sensing fibre 402 may be a standard, unmodified single mode optic fibre such as is routinely used in telecommunications applications, although multimode fibre may be used in some applications (typically with reduced performance). The sensing fibre need not include any deliberately introduced reflection sites such a fibre Bragg grating or the like, but in some implementations some such reflection sites could be present, or the fibre may be one which has been fabricated or processed to provide greater scattering than a conventional telecommunications optical fibre.

The sensing fibre 402 may be deployed in an area of interest to be monitored and, in some cases, may be specifically deployed to allow for sensing. Depending on the particular use case, the sensing fibre may be deployed in a relatively permanent manner, e.g. being buried or otherwise secured in place. The interrogator 401 may be removably coupled to the sensing optical fibre 402 (possibly via some optical connection which may include a connecting optical fibre), and thus in some instances, if continuous monitoring is not required, the interrogator 401 may be removed from the sensing fibre 402 when sensing is not required, possibly leaving the sensing fibre in situ. In some instances, use may be made of an existing optical fibre which is already deployed in the region of interest, and which may have been originally deployed for some other performance, e.g. for communications. Note whilst the sensing fibre may be one continuous optical fibre, the sensing fibre could, in some applications, be formed from various optical fibre sections that have been spliced together or otherwise optically connected.

In use, the interrogator 401 repeatedly interrogates the sensing optical fibre 402 with coherent optical radiation and analyses the backscatter therefrom. The interrogator 401 thus comprises an optical source, in this example a laser 403, for generating coherent optical radiation and a modulator 404 for modulating the output of the laser. The modulator 404 modulates the output of the laser 403 so as to repeatedly interrogate the sensing fibre with optical radiation, which will be referred to herein as interrogating radiation, in a series of interrogations.

Note that as used herein the term “optical” is not restricted to the visible spectrum and, as used herein, the term optical refers to any electromagnetic radiation which may be guided by, and scattered from within, an optical fibre. For the avoidance of doubt, optical radiation as used herein includes infrared radiation and ultraviolet radiation. Any reference to “light” should also be construed accordingly.

The interrogator 401 of FIG. 4 is operable in a frequency swept mode of operation, in which the frequency of the interrogating radiation may be controllably varied between interrogations. FIG. 4 thus illustrates a frequency modulator 405 which is operable to apply a controlled frequency modulation. The frequency modulator 405 may be controlled by a controller 406.

Note that FIG. 4 illustrates that the frequency modulator 405 is separate to the modulator 404 for clarity, but in practice the functionality of these modulators could be at least partly combined and/or in some embodiments the laser 403 could be a frequency tuneable laser and at least some of the frequency modulation may be applied by tuning the output frequency/wavelength of the laser. In general therefore the interrogator comprises an output optical path, which in this example includes the laser source 403, first optical modulator 405 and second optical modulator 404, which is configured to repeatedly interrogate a sensing optical fibre by launching coherent optical radiation into the sensing optical fibre, and where the frequency of the interrogating radiation can be controllably varied.

Interrogating optical radiation which is Rayleigh backscattered from the sensing optical fibre is detected by a photodetector 407. In some implementations the backscatter may be mixed, by mixer 408, with a local oscillator signal derived from the laser 403. In some embodiments the local oscillator signal LO may be tapped from upstream of the modulator 404, and the modulator 404 may be configured to apply a fixed modulation of optical frequency to the interrogating radiation, as to introduce a frequency difference between the Rayleigh backscatter and the local oscillator, thus defining a carrier frequency. The modulator 404 may therefore apply a modulation of optical frequency, and hence wavelength, but the amount of this modulation is fixed. The frequency modulator 405 is configured to apply a controllably variable amount of frequency modulation. The local oscillator may be tapped from downstream of the frequency modulator 405, so that the local oscillator signal includes the effect of the controlled frequency modulation. The modulator 404 may then apply the fixed modulation to the interrogating radiation launched into the sensing fibre 402 so as to provide the frequency difference between the Rayleigh backscatter and the local oscillator. In this way the frequency of the interrogating radiation varies, but the carrier frequency remains the same, which may ease the detection and processing of the carrier signal.

The backscatter (possibly mixed with the local oscillator LO) is detected by the photodetector 407 and the detected backscatter signal is processed by processor 408 to provide an output.

The detected backscatter signal can be processed in suitable time bins to determine a measurement value for each of one or more sensing portions of the sensing fibre for each of a plurality of different frequencies of interrogating radiation. In some implementations, the measurement value could be the signal level, e.g. intensity, for the relevant sensing portion. In implementations where the backscatter is interfered to generate a carrier signal component at a defined carrier frequency, the measurement value could be the carrier level.

The interrogator 401 is configured to generate a measurement value for each sensing portion for each of the plurality of different frequencies of interrogating radiation, so as to provide a backscatter spectral profile for each sensing portion.

For each individual interrogation in the frequency swept mode, the frequency of the interrogating radiation may not vary significantly during the course of the interrogation and, in some cases, the frequency of the interrogating radiation for each individual interrogation may be substantially constant. However the frequency varies between different interrogations. The frequency of the interrogating radiation may be varied over a desired frequency range over a set of a plurality of interrogations to allow generation of a profile for each sensing portion. The set of interrogations may thus be performed over a profile acquisition period to allow generation of the backscatter spectral profile.

It will be understood by one skilled in the art that some distributed fibre optic sensors are known which use an optical source which generates a frequency swept output which is launched into the sensing fibre, for instance fibre optic sensors based on optical frequency domain reflectometry. In such sensors the optical frequency (and hence wavelength) is varied significantly over the course of each interrogation and frequency analysis is applied to the backscatter. This requires the use of relatively complex spectral analysis to determine how the backscatter power varies with frequency and the range of such OFDR sensors is relatively extremely limited.

By contrast, where each interrogation comprises interrogating optical radiation which is substantially constant at a given frequency, there may be a relatively large amount of optical radiation launched at that wavelength, which means than a backscatter signal above the noise floor of the sensor apparatus can be received from a much longer range into the sensing fibre. In particular, where the backscatter is mixed with a local oscillator, which, as will be understood by one skilled in the art, provides a degree of amplification for the backscatter, a sensing range of up to 100 km or more may be achievable. In addition, as the backscatter from each interrogation is simply processed to provide a single measurement value, complex spectral analysis, e.g. FFTs and the like or multiple filters, are not required.

The difference or separation in frequency between the different interrogations is selected so as to provide sufficient detail in the resulting backscatter spectral profile to allow correlation between profiles acquired at different times. Generally the backscatter spectral profile has a characteristic scale of 2π radians, i.e. the characteristic separation between peaks in profile 101 of FIG. 1a is such that when that frequency change is applied over the length of a sensing portion it leads to a phase change of 2π rad. Thus the separation in frequency, between adjacent frequencies of the set of interrogations that form the backscatter spectral profile, may differ from one another by an amount that causes a phase change, say, 2 radians or less over a sensing portion. For instance, in some examples a frequency variation between adjacent frequencies in the set that corresponds to about 1 radian or so for the sensing portion should be sufficient to allow characterisation of the backscatter spectral profile.

In embodiments of the present disclosure, the frequency range over which the interrogating radiation may be varied, i.e. the range over which the laser 403 and/or frequency modulator 405 may be scanned, may be relatively limited. The processor 208, when operating in the frequency swept mode, may thus operate to generate a reference profile from a plurality of acquired backscatter spectral profiles as discussed above. For instance the processor 408 may be operable to perform the method discussed with reference to FIG. 3.

In some embodiments the interrogator 401 may also be operable in a COTDR mode of operation, in which the controller 406 controls the output optical path, i.e. laser 403, modulator 404 and frequency modulator 405, to repeatedly interrogate the sensing fibre 402 with optical radiation where the frequency characteristics are the same from one interrogation to the next, and thus the laser 403 may a low-noise laser 403 as is suitable for COTDR.

The interrogator 401 may thus be operable in COTDR mode of operation, which may be a standard Rayleigh COTDR sensing mode, and also in a frequency swept mode of operation in which a backscatter spectral profile characteristic is determined for at least one sensing portion.

In the COTDR mode of operation, the controller 406 may control the laser 403 and/or frequency modulator 404 such that the frequency of interrogating radiation launched into the sensing fibre 402 is the same for each interrogation. Thus, the controller 406 may control the frequency modulator 405 in the first mode, so that there is either no frequency modulation applied or that a fixed frequency modulation is applied which is the same for each interrogation.

In the frequency swept mode of operation, the controller 406 may control the laser 403 and/or frequency modulator 405 such that the frequency of interrogating radiation launched into the sensing fibre 402 varies between interrogations.

The processor 408 may process the detected backscatter signal in different ways depending on the mode of operation, as may be controlled by the controller 406.

For a phase based coherent Rayleigh distributed fibre optic sensor the processing by processor in the COTDR mode will generally determine a phase value from the backscattered light, e.g. the phase of a signal component at a defined carrier frequency. A signal component at a defined carrier frequency can be generated in various ways. For instance, each interrogation in the COTDR mode may comprise two optical pulses at different optical frequencies to one another, where the frequency difference between the pulses defines the carrier frequency. In such a case, backscatter from both pulses may interfere to provide a signal component at the carrier frequency. Alternatively, backscatter from a pulse at a given optical frequency may be mixed with a local oscillator signal LO, where the optical frequency of the local oscillator differs from that of the backscatter by the defined carrier frequency. The backscatter signal may be demodulated to provide a phase value for different sensing portion of the optical fibre as will be understood by one skilled in the art, possibly after down conversion to a baseband signal and then. The difference in phase value for the different sensing portions from the repeated interrogations in the COTDR mode of operation can be used to provide a measurement signal for each of the relevant sensing portions of the sensing optical fibre (also referred to as channels of the distributed fibre optic sensor). Such phase based COTDR operation may provide a quantitative value for the amount of change of path length of sensing portion that is more sensitive than operation in the frequency swept mode of operation. However, if the phase value changes by more than IT radians between each interrogation, as can happen with short, high amplitude, impulsive events, demodulation errors can be introduced.

In some implementations, the interrogator may be selectively operated in a selected one of the COTDR mode or the frequency swept mode of operation for a particular application. As noted above COTDR sensing is generally more sensitive and provides an updated measurement per interrogation so may be preferred when continuous and/or more accurate sensing is required. However COTDR mode operation requires continuous use. If the state of the sensing fibre only needed to be monitored periodically, frequency swept mode operation may be preferred.

It would be possible to carry out COTDR sensing and swept frequency operation simultaneously, however the sweeping of the laser would introduce an extra signal on to that obtained from the COTDR sensing. This additional signal would have the same form and similar amplitude on each spatial channel and so could be removed relatively easily by signal processing.

In some implementations, periodic operation in the frequency swept mode may be used to calibrate operation in the COTDR mode of operation, to identify and compensate for any demodulation errors. For instance, the indication of any change in optical path length determined from periods of operation in the frequency swept mode of operation, can be used to calculate the phase change that should be measured by the COTDR operation for the same sensing portion, and if they differ by more than ±π radians (i.e. there is a difference value with a magnitude greater than π radians) it may be assumed that this is due to demodulation error, e.g. steps, being induced in the COTDR signal generated in the first mode for the sensing portion. A correction may then be applied to the COTDR signal of 2nπ radians, where n is an integer and is chosen so that the phase change in the COTDR signal now matches, to within ±π radians, that which is calculated from repeated operation in the second mode, i.e. the frequency swept mode of operation.

The distributed fibre optic sensing apparatus may, in use, generally operate in the COTDR mode to provide generally continuous monitoring of the sensing fibre, but at intervals may operate in the frequency swept mode.

In use for a particular application, the distributed fibre optic sensing apparatus 400 may thus be initially operated in the frequency mode to establish a reference profile for one or more sensing portions or channels of the sensing fibre. The distributed fibre optic sensing apparatus 400 can be operated to acquire a plurality of backscatter spectral profiles for each sensing portion which may be combined to form the initial reference profiles as discussed above.

Subsequently the distributed fibre optic sensing apparatus 300 may switch to the COTDR mode of operation and may generate COTDR sensing data for the one or more sensing portions or channels of the sensing optical fibre. At various intervals, however, the distributed fibre optic sensing apparatus 400 may switch to the frequency swept mode of operation to acquire a new backscatter spectral profile for the one or more sensing portions, before returning to the COTDR mode of operation. For each sensing portion, the newly acquired backscatter spectral profile can be compared to the reference profile to determine an expected change in optical path length or expected phase change in the COTDR sensing data between profile acquisitions and any correction applied to the COTDR data as necessary.

In some instance the intervals between operation in the frequency swept mode may be pre-defined and may occur at any desired interval which could be regular or irregular. In some cases, the spacing of the intervals of operation in the frequency swept mode could vary according to known or expected noise conditions, e.g. there may be more frequent instances of operation in the frequency swept mode when more background noise is expected. In some cases, operation in the frequency swept mode could additionally or alternatively be triggered by one or more events. For instance, if a sensing fibre is deployed for long term monitoring near a rail tack, passage of a train on the track may cause high amplitude strain that could lead to demodulation errors, and thus an instance of operation in the frequency swept mode could be triggered by passage of a train. In some cases, operation in the frequency swept mode could be triggered by an analysis of the COTDR data, i.e. if something appears anomalous in the COTDR sensing data, an instance of operation in the second mode could be triggered to provide calibration.

Additionally or alternatively. in some cases the operation in the COTDR may be used to determine the extent of a phase change for a sensing portion which can be used to determine when to operate in the frequency swept mode so as to acquire a backscatter spectral profile that may be able to extend the reference profile.

Embodiments of the present disclosure thus relate to frequency swept Rayleigh backscatter based distributed fibre optic sensing, where multiple backscatter spectral profiles are acquired over a given frequency range and combined to provide a reference profile over a greater frequency range. This can allow the principles of frequency swept Rayleigh backscatter to be applied to sensing apparatus that is capable of being swept over a relatively limited frequency range, such as may be appropriate for COTDR operation. Acquiring the backscatter spectral profile over a relatively limited frequency range also means the time required to acquire the profile is also limited.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A fibre optic sensing apparatus, comprising:
an optical output path configured to repeatedly interrogate a sensing optical fibre by launching coherent optical radiation into the sensing optical fibre;
a detector configured to receive optical radiation that is Rayleigh backscattered from the sensing optical fibre and output a detected backscatter signal in response to each interrogation; and
a processor for processing the detected backscatter signal;
wherein the fibre optic sensing apparatus is operable in a frequency swept mode in which the sensing optical fibre is interrogated with a first set of interrogations of coherent optical radiation having different optical frequencies from one another to acquire, for at least one sensing portion of the sensing optical fibre, a backscatter spectral profile of a measurement value of the detected backscatter signal with frequency across a first frequency range; and
wherein the processor is configured to combine a plurality of said backscatter spectral profiles to form a reference profile with an effective frequency range greater than the first frequency range.

2. The fibre optic sensing apparatus of claim 1 wherein the processor is configured to:
identify at least first and second backscatter spectral profiles acquired across the first frequency range, in which there is a common part of the first spectral backscatter spectral profile that, with an apparent frequency shift, is the same as a common part of the second backscatter spectral profile and in which parts of each of the first and second backscatter spectral profiles are different from one another; and
combine the first and second backscatter profiles to form the reference profile to include the part of the first profile backscatter spectral profile which is different to the second backscatter spectral profile, the common part of the first and second backscatter spectral profiles and the part of the second profile backscatter spectral profile which is different to the first backscatter spectral profile.

3. The fibre optic sensing apparatus of claim 2 wherein the part of the reference profile that corresponds to the common part of the first and second backscatter spectral profiles is formed by averaging the common parts of the first and second backscatter spectral profiles.

4. The fibre optic sensing apparatus of claim 1 wherein the processor is configured to compare an existing reference profile with an acquired backscatter spectral profile over the first frequency range to determine the extent of any apparent frequency shift.

5. The fibre optic sensing apparatus of claim 4 where the processor is configured to determine the apparent frequency shift by cross-correlating the acquired backscatter spectral profile with the reference profile.

6. The fibre optic sensing apparatus of claim 4 wherein the processor is configured to determine whether, with the determined apparent frequency shift applied to the existing reference profile, part of the acquired backscatter spectral profile extends beyond the existing reference profile and, if so, to combine acquired backscatter spectral profile with the existing reference profile to create a new reference profile that includes the part of the acquired backscatter spectral profile extends beyond the existing reference profile.

7. The fibre optic sensing apparatus of claim 4 wherein the processor is configured to output an output signal indicative of the determined apparent frequency shift.

8. The fibre optic sensing apparatus of claim 1 wherein the processor is configured to combine a plurality of acquired backscatter spectral profiles to generate a measurement profile and to compare the measurement profile to the reference profile to determine the extent of any apparent frequency shift and to output an output signal indicative of the determined apparent frequency shift.

9. The fibre optic sensing apparatus according to claim 4 in which the processor is configured to determine a magnitude of change in strain and/or temperature based on the determined apparent frequency shift.

10. The fibre optic sensing apparatus of claim 1 wherein the processor is configured to determine the measurement value as the signal level of the detected backscatter signal.

11. The fibre optic sensing apparatus of claim 1 further comprising a mixer for mixing the optical radiation that is Rayleigh backscattered from the sensing fibre with a local oscillator derived from the optical output path prior to detection by the detector, wherein the optical output path is configured such that there is an optical frequency difference between the local oscillator and the optical radiation that is Rayleigh backscattered from the sensing fibre, and the processor is configured to determine the measurement value as a carrier level of a carrier component in the detected backscatter signal at a carrier frequency equal to said optical frequency difference.

12. The fibre optic sensing apparatus of claim 1 wherein the fibre optic sensing apparatus is operable in a COTDR mode, in which the sensing optical fibre is repeatedly interrogated coherent optical radiation, wherein the interrogations in the COTDR mode have the same frequency characteristics as one another and the detected backscatter signal is processed to determine, for at least one sensing portion of the sensing optical fibre, a phase value indicative of any changes in optical path length and to output a COTDR output signal based on said determined phase value.

13. The fibre optic sensing apparatus of claim 12 wherein said optical output path comprises a first laser and the apparatus is configured to use the first laser in each of the frequency swept mode and the COTDR mode.

14. The fibre optic sensing apparatus of claim 12 wherein the apparatus is configured to operate in the COTDR mode in intervals between periods of operation in the frequency swept mode and the processor is configured to use an indication of any change in optical path length determined from periods of operation in the frequency swept mode of operation to identify and/or correct any demodulation errors in the COTDR output signal.

15. The fibre optic sensing apparatus of claim 12 wherein the apparatus is configured to operate in the COTDR mode both during the periods of operation in the frequency swept mode and during the periods between them, and the processor is configured remove a signal component induced by the frequency sweep from a COTDR output signal generated in the COTDR mode.

16. The fibre optic sensing apparatus of claim 15 that uses an indication of any change in optical path length determined from periods of operation in the frequency swept mode of operation to identify and/or correct any demodulation errors in the COTDR output signal.

17. A method of fibre optic sensing comprising:
repeatedly interrogating a sensing optical fibre by launching coherent optical radiation into the sensing optical fibre;
a detecting optical radiation that is backscattered from the sensing optical fibre and output a detected backscatter signal in response to each interrogation; and
processing the detected backscatter signal;
wherein the method comprises operating in a frequency swept mode in which the sensing optical fibre is interrogated with a first set of interrogations of coherent optical radiation having different optical frequencies from one another to acquire, for at least one sensing portion of the sensing optical fibre, a backscatter spectral profile of a measurement value of the detected backscatter signal with frequency across a first frequency range; and
combining a plurality of said backscatter spectral profiles to form a reference profile with an effective frequency range greater than the first frequency range.
